(19) United States
(12) Patent Application Publication
(10) Pub. No.: US 2026/0029754 A1
(43) Pub. Date: Jan. 29, 2026

(54) METHOD OF MANUFACTURING A TIMEPIECE COMPONENT

(71) Applicant: ROLEX SA, Geneva (CH)

(72) Inventors: Sylvain Farine, Bevaix (CH); Philippe Vaucher, Sonceboz-Sombeval (CH)

(73) Assignee: ROLEX SA, Geneva (CH)

(21) Appl. No.: 19/274,971

(22) Filed: Jul. 21, 2025

(30) Foreign Application Priority Data
Jul. 24, 2024 (EP) 24190559.5

(51) Int. Cl. G04D 3/00; G04B 3/04

(52) U.S. Cl. CPC G04D 3/0069; G04B 3/04

(57) ABSTRACT

The method of manufacturing a timepiece component includes: procuring a block to be machined; forming a timepiece component blank having a shape of revolution about a revolution axis (A); and machining the blank using an off-center laser beam the direction of which is not parallel to the revolution axis (A), does not cross the revolution axis (A) and is not tangential to the blank to be machined.

### CROSS-REFERENCE TO RELATED APPLICATION

This application claims priority of European patent application No. EP24190559.5 filed Jul. 24, 2024, the content of which is hereby incorporated by reference herein in its entirety.

### Field of the Invention

The present invention concerns a method of manufacturing a timepiece component. It also relates to a machining device that employs such a method of manufacture.

### Background Art

The manufacture of a timepiece component necessitates a good trade-off between the following requirements:
a high-performance material that at the very least addresses the high mechanical requirements imposed by the timepiece application;
a method of manufacture sufficiently simple to envisage use on a large scale, reliably and robustly.

A first existing solution consists in manufacturing a metal timepiece component by a turning process involving a mechanical cutting tool that acts directly in contact with an initial block to shape it by removal of material. This cutting tool comes into direct contact with the block, in contrast to laser machining in which a laser beam enables working remotely on such a block. Such a method enables high precision to be obtained rapidly and under good control. Depending on the alloy used, a metal nevertheless has the disadvantage of being sensitive to magnetic fields, which can lead to problems of reliability in the operation of a watch under some circumstances of use. Furthermore, a metal is not always sufficiently hard and necessitates complementary operations to increase its hardness and sometimes its surface state, which in the end complicates the method of manufacture. Finally, some hard amagnetic alloys prove to be too difficult to machine because they cause excessively high wear of the cutting tools.

A second existing solution relies on the choice of a very rigid amagnetic material such as a ceramic which is free of some defects of the metal used in the first solution. However, the manufacture of a ceramic timepiece component necessitates a more complex process generally involving laser machining, which is more difficult to control and slower than traditional machining. In fact, laser machining cannot be used to manufacture components that have complex three-dimensional geometries, in particular with the high precision necessary for a timepiece component to function correctly. For example it is not possible to machine teeth having certain complex shapes. Furthermore for some products such as an escapement pinion components are manufactured separately and then driven onto a shaft, which generates play problems and risks of breakage.

### SUMMARY OF THE INVENTION

The present invention therefore has for object proposing a solution for the manufacture of a timepiece component that constitutes the best possible response to the requirements mentioned above and improves on existing solutions.

To be more precise the invention has for object to define a timepiece component manufacturing solution enabling a timepiece component with optimized mechanical properties to be manufactured reliably and robustly.

To this end, the invention is based on a method of manufacturing a timepiece component including the following steps:
procuring a block to be machined;
forming a timepiece component blank having a shape of revolution about a revolution axis;
   wherein it includes a step consisting in:
machining the blank using an off-center laser beam the direction of which is not parallel to the revolution axis, does not cross the revolution axis and is not tangential to the blank to be machined.

The block to be machined can exist entirely of ceramic, preferably a sintered and hardened ceramic.

The invention also relates to a machining device including at least one rotating spindle configured to hold a block to be machined and a laser that can be off-centered that is configured to employ a method as described above of manufacturing a timepiece component.

The invention also relates to a timepiece component made of a material with a hardness greater than or equal to 800 HV or greater than or equal to 1000 HV or greater than or equal to 1200 HV, in particular a ceramic based on zirconia or alumina, wherein it has a monobloc structure comprising a shaft and at least one tooth, a section of which on a plane perpendicular to the shaft has a shape including a flared profile portion, the section normal to the shaft having a shape in which the orthoradial dimension increases in the direction radially away from the shaft.

The invention is defined more precisely by the claims.

### BRIEF DESCRIPTION OF THE DRAWINGS

These objects, features and advantages of the present invention are disclosed in detail in the following non-limiting description of particular embodiments given with reference to the appended figures, in which:

FIG. 1 represents a schematic view of the transverse profile of an escapement pinion that can be manufactured by the method of manufacture according to the invention.

FIG. 2 represents a schematic view of a phase of machining an escapement pinion in a first phase of a third step of the method of manufacture according to one embodiment of the invention.

FIG. 3 represents schematically layer by layer laser treatment of an escapement pinion blank according to a first approach of a first phase of a third step of the method of manufacture according to this embodiment of the invention.

FIG. 4 depicts the distribution in time and the duration of the laser shots for the layers represented in FIG. 3.

FIG. 5 represents schematically laser treatment of an escapement pinion blank according to a second approach of a first phase of a third step of the method of manufacture according to this embodiment of the invention.

FIGS. 6 and 7 represent schematically laser treatment of an escapement pinion blank according to a first approach of a second phase of a third step of the method of manufacture according to this embodiment of the invention.

FIGS. 8 and 9 represent schematically laser treatment of an escapement pinion blank according to a second approach of a second phase of a third step of the method of manufacture according to this embodiment of the invention.

FIG. 10 represents a perspective view of a timepiece component according to one embodiment of the invention.

### DETAILED DESCRIPTION OF PARTICULAR EMBODIMENTS

To simplify the description and by convention the longitudinal direction is the main direction along which the timepiece component concerned and/or specifically a axis of revolution of a timepiece component extends. The adjective “transverse” is used to designate a direction perpendicular to the longitudinal direction.

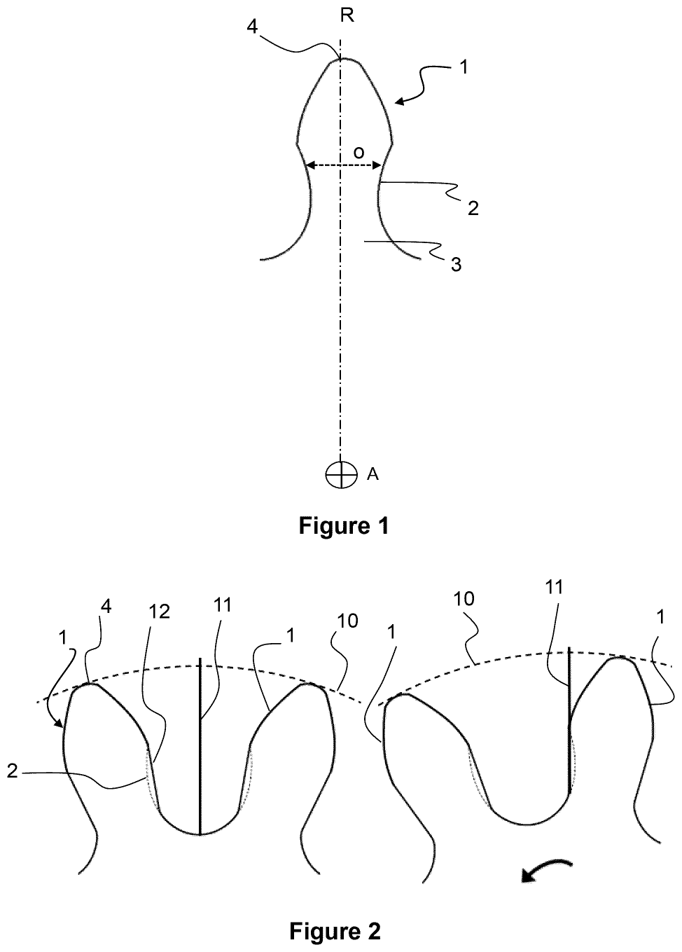

The invention is described in the context of the production of an escapement pinion comprising identical teeth a transverse profile of which, that is to say a profile of which in a transverse plane, in other words a section on a plane perpendicular to the revolution axis A of the escapement pinion, is represented in FIG. 1. Such a tooth profile 1 has a shape that has a particular feature of including a portion 2 referred for simplicity as a “flared portion” in which the orthoradial dimension o evolves positively in the direction radially away (the direction R) from the shaft of the escapement pinion, that is to say the direction R extending from the base 3 of a tooth toward its crown 4.

In particular, the profile of such a tooth can have an ogival shape comprising a reduction of the thickness of the tooth below the primitive diameter of the pinion. The utility of such pinion teeth is to allow optimized initial interaction between two meshing teeth thanks to an upper part with the primitive diameter of the pinion designed to mesh efficiently at the start of movement. At the same time the reduction of thickness at the bottom of the tooth, that is to say at its root, ensures adequate disengagement from the opposite tooth, guaranteeing a fluid and precise transfer of motion. This mechanism minimizes friction and favors increased durability of the meshing assembly.

The concept of the invention consists in using a method of manufacture based on a particular kind of laser machining that in particular enables such a tooth profile to be manufactured efficaciously.

A method of manufacture enabling manufacture of an escapement pinion having identical teeth with the tooth profile described hereinabove is described in detail next.

The method of manufacture comprises a first step consisting in procuring a block to be machined. This block to be machined is advantageously made entirely of a ceramic. The ceramic is preferably homogenous throughout the monobloc block to be machined. It is advantageous to use a technical ceramic and preferably a sintered technical ceramic. The adjective “technical” refers to the high-performance properties of the chosen ceramic. In fact a technical ceramic can achieve excellent mechanical, thermal and even electrical and/or biochemical properties in addition to chemical inertness and amagnetism, which renders it appropriate for use in a timepiece component. The technical ceramics used here differ from traditional ceramics in their composition, in that they are obtained from purified synthetic powders and not from natural mineral powders such as feldspar or kaolin, for example. By way of example, the ceramic can be based on zirconia, in particular yttria stabilized zirconia, alumina, a zirconia-alumina composite material, silicon carbide or silicon nitride. Alternatively, the block to be machined includes a ceramic coating.

The ceramic can comprise, in addition to zirconia and/or alumina and/or some other type of ceramic, one or more of the following elements:
carbon nanotubes,
graphene,
fullerenes,
yttrium oxide,
cerium oxide,
zirconium carbide,
titanium carbide,
zirconium boride,
boron nitride,
titanium nitride.

More generally, the material of the block to be machined is advantageously a rigid and/or fragile and/or hard material with a hardness greater than or equal to 500 HV or even greater than or equal to 600 HV or even greater than or equal to 700 HV or even greater than or equal to 800 HV or even greater than or equal to 1000 HV or even greater than or equal to 1200 HV.

As an alternative to ceramics, the block to be machined can be made of metal or a metal alloy, in particular stainless steel or austenitic steel or martensitic steel, or an amorphous or partially amorphous metal alloy, or a titanium alloy Ti, or tungsten or a zirconium alloy. Alternatively, the material of the block to be machined can be a cermet. In a further alternative the material can be a combination of the materials mentioned above.

The method of manufacture then employs a second step consisting in forming a timepiece component blank that has a shape of revolution about a revolution axis A.

This blank can be obtained by various traditional methods such as extrusion of a mixture of powder and binder or micro-injection. In a preferred embodiment the blank is formed by machining: to this end, the block to be machined is mounted on a machining spindle and driven in rotation. The flanks of the blank are then profiled by turning or laser turning in the traditional manner. In particular, in the case of laser turning the laser beam can have a significant energy of around 30 μJ. The laser beam can be used with precession.

The method of manufacture then employs a third step of machining a blank that may comprise two phases. This machining step advantageously employs a laser, which can be a laser functioning at a wavelength of 515 nm or alternatively at a wavelength of 1030 nm.

In a first phase the blank obtained in the preceding second step is machined by a laser machining device which can be the same device used to form the blank. The laser, which is employed without precession, is preferably a laser producing an ultrashort pulse of the picosecond or ideally femtosecond pulsed type (pulse length of the order of 500 fs or even 400 fs or even less than 400 fs). This prevents the laser heating the material. In this first phase the laser beam functions in the same plane as the revolution axis A of the blank, perpendicularly or substantially perpendicularly to the revolution axis A. For this reason, it is called a “centred laser”. The laser beam therefore machines the part over its length and in particular cuts away a part of the future escapement pinion teeth. FIG. 2 depicts this phase schematically. The curve 10 represents the initial shape of the blank. The curve 12 represents the shape of the teeth obtained by this first machining phase using a laser beam 11. FIG. 2 further represents particular flared portions 2 described above of the finalised teeth to be manufactured. In this first machining phase this flared portion 2 of the teeth cannot be formed because the wide part toward the crown 4 of the teeth blocks the passage of the laser beam 11 and prevents the formation of the flared portion 2. FIG. 2 further shows that the movement of the laser beam 11 as depicted by the left-hand and right-hand views in FIG. 2 enables machining of an entire volume extending between two adjacent teeth 1.

Laser machining can employ two different approaches in this first phase.

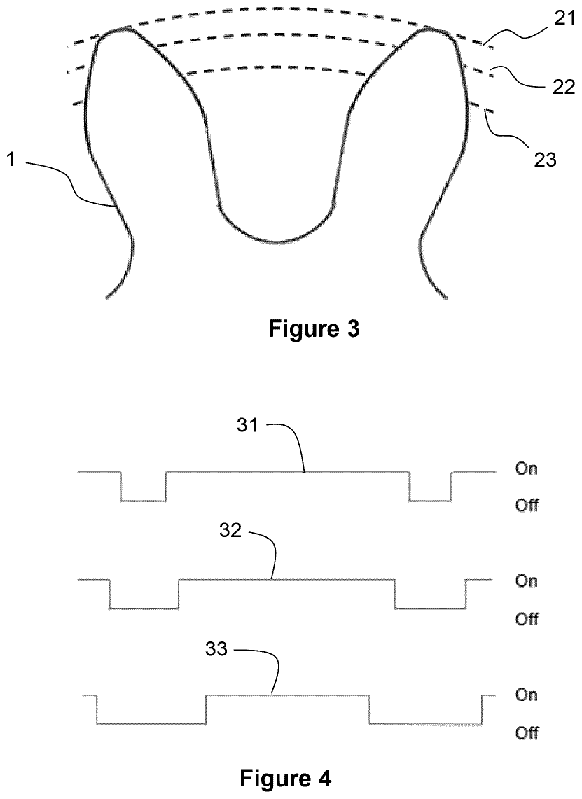

Using a first approach machining is carried out continuously over all of the circumference of the blank, which is driven in rotation around its axis of revolution A on a rotating spindle of the machining device. Laser shots are applied sequentially to generate laser pulses and preferably to form the teeth by removing material layer by layer between the tooth crowns. The rotation speed of the spindle can be greatly reduced compared to that used for example to shape a blank using the same laser machining device. The laser shots are synchronised with the rotation of the blank and form the required teeth and hollows shown by the curve 12 in FIG. 2. FIGS. 3 and 4 depict the use of this first approach. FIG. 3 represents three curves 21, 22, 23 that correspond to three distinct layers treated by laser during rotation of the blank. FIG. 4 depicts the distribution in time and the duration of the laser shots for each of said three layers, in other words depicts the intermittent laser shots for each layer 21, 22, 23. Each high (On) part of each of the three lines represents a respective laser shot 31, 32, 33, the low (Off) parts representing interrupted laser phases during which material is not removed and therefore remains on the blank to form part of the teeth being formed.

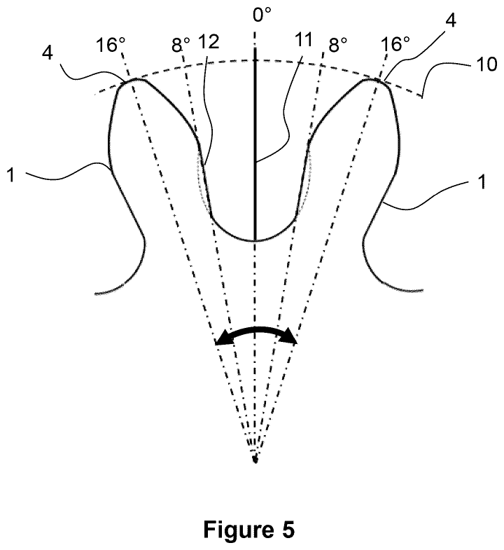

In a second approach that is an alternative to the first approach laser machining is carried out individually for each tooth. In this case the laser functions in a continuous sequence and is moved relative to the blank to perform oscillations calculated to enable machining between two teeth. The laser removes material layer by layer. The repeated passage of the laser is therefore used to machine more deeply at the center of the oscillation. The amplitude of the oscillation of the blank is determined by a number of factors such as the geometry of the required part, the power of the laser expressed by the laser fluence and the focusing diameter. The oscillation angle is preferably adjusted so that the laser beam 11 reaches the crowns 4 of two adjacent teeth 1. FIG. 5 represents more particularly use in according with this second approach. Consider the example of a pinion with 10 identical and symmetrical teeth. With a laser focusing diameter of approximately 12 μm and a distance between the crowns of two teeth of approximately 125 μm, the angle of oscillation of the part to be machined between two teeth 1 is approximately +/−16°, centered on the roots of the teeth. By reducing this angle (to 8° in the figure) during an additional time period it is possible to carry out deeper machining at the roots of the two teeth 1 to produce the final profile shown by the curve 12, which differs from the required final profile, notably by not producing the portions 2.

As has been described the first machining phase enables a first cutting of the teeth of the escapement pinion but without achieving the required final profile.

For this reason, the third machining step employs a second laser machining phase during which the alignment of the laser is offset from the axis of revolution of the blank, which is to say that the laser beam 11 generated is neither aligned with the revolution axis of the blank nor oriented in such a manner as to cross the revolution axis. Note also that the laser beam is not tangential to the edge of the blank either, that is to say is not used with tangential incidence on the machined surface. The laser is simply referred to in a simplified manner as an “offset laser” or “off-center laser” in the remainder of the description. This reorientation of the laser enables extremely precise machining of the final shape of the teeth 1, notably of the particular flared portions 2 described in detail above.

To this end, the laser is offset to one side of the revolution axis of the blank so that its laser beam 11 is able to reach a tooth 1 under the primitive diameter of the blank without striking the wider upper part of the tooth 1. This therefore enables removal of material over all of the depth and the thickness required to finalize the complex complete profile of said tooth 1.

The power of the laser is advantageously reduced in this second phase: the pulsed laser energy fluctuates between 1 and 20 μJ for example. The speed of rotation of the blank can likewise be significantly reduced to enable precise machining of said particular portions 2.

This second laser machining phase can also be employed with two different approaches.

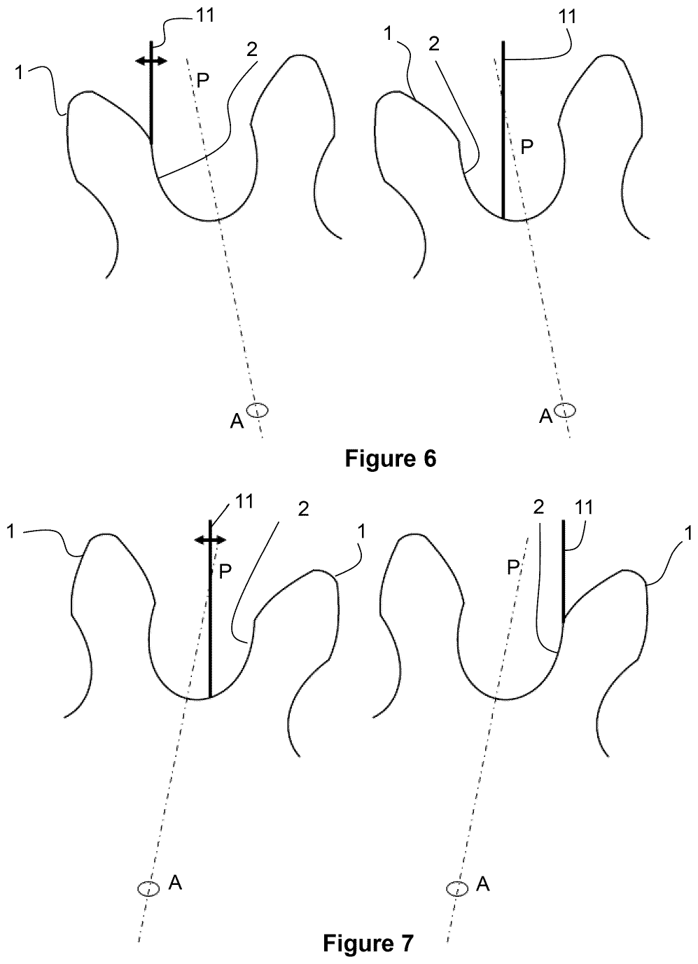

In a first approach the blank is immobilized and oriented relative to the laser so that the laser beam has direct access to the roots of the teeth without without obstruction from the end parts of the teeth. The laser is then moved away from or toward the revolution axis by movement in translation of the laser beam 11 or by pivoting of the laser beam or by a combination of these two movements. FIG. 6 depicts the finalization of the laser machining on one side of a first tooth using this first approach. FIG. 7 depicts the finalization of the laser machining on the other side of an adjacent second tooth using this first approach with symmetrical off-centering of the laser relative to a plane P of symmetry of said two adjacent teeth 1, this plane P of symmetry containing the revolution axis A of the blank. In these two FIGS. 6, 7 the left-hand figure and the right-hand figure depict the movement of the laser beam 11 at the level of the flared portion 2 being formed. As is apparent in these figures the laser beam is not oriented in a direction that crosses the revolution axis A of the blank, unlike in the laser machining described with reference to FIGS. 2 and 5. The laser beam is advantageously oriented in a direction perpendicular to the revolution axis A or at an angle of 90° to the revolution axis A, this angle being defined by the directional mathematical vector of the straight line segment defined by the laser beam when it does not cross this revolution axis A, as mentioned above. It is simply that the laser has a direction perpendicular to the revolution axis A. More generally, this direction is at an angle between 45 and 90 degrees or even between 70 and 90 degrees or even between 80 and 90 degrees to the revolution axis A of the blank.

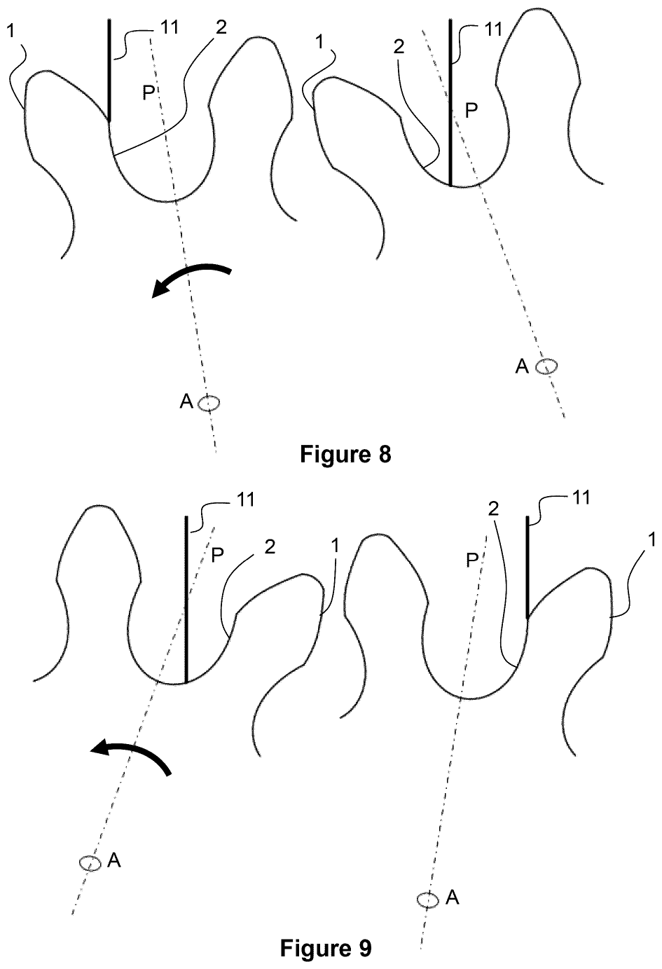

Using a second approach the laser beam is immobilized and oriented relative to the blank so that the laser beam has direct access to the tooth roots without obstruction from the end parts of the teeth. Thus in contrast to the first approach it is the blank that pivots slightly around its revolution axis A to provide direct access to the zone of the blank to be machined to form the flared portion without obstruction from the end part of the tooth, which is already finished and must not be machined. FIG. 8 depicts the finalization of the laser machining on one side of a first tooth using this second approach. FIG. 9 depicts the finalization of the laser machining on the other side of an adjacent second tooth using this second approach after symmetrical off-centering of the blank relative to a plane P of symmetry of said two adjacent teeth 1, this plane P of symmetry containing the revolution axis A of the blank. In these two FIGS. 8, 9 the left-hand figure and the right-hand figure depict the change of inclination of the blank relative to the laser beam 11, in particular at the level of the flared portion 2 being formed. As is apparent in these figures the laser beam retains an orientation relative to the blank similar to that described with reference to the first approach, in accordance with the “off-center laser” principle.

Alternatively, a combination of the two approaches can naturally be envisaged, the machining zone of the blank being attacked by moving the laser beam and the blank in a coordinated manner around its revolution axis. By way of an example of the use of this third approach the laser beam can machine the roots of two adjacent teeth if at the same time the blank is pivoted about its revolution axis to give the laser direct access alternately to the roots of the two adjacent teeth without obstruction from the end part of said two adjacent teeth. This combined approach in the end enables machining of half of two adjacent teeth simultaneously or quasi-simultaneously, that is to say in the same operation. This approach therefore has the advantage of reducing the machining time of the second phase relative to the two previous approaches.

In all cases the third step employs the second phase described hereinabove that forms the core of the concept of the invention to enable complex shapes of timepiece components to be obtained simply, in particular at least one flared portion of at least one tooth. This second phase ends in a step in which the laser beam and the blank are driven in relative movement appropriate to the required result, whereas the laser is off-center that is to say that relative to the straight line segment defined by the incident laser beam, its axis is not aligned with and more generally not parallel to the revolution axis of the blank, does not cross this revolution axis of the blank and is not tangential to the blank to be machined either.

Note that in this third step the first phase is optional. Depending on the geometries to be machined it can be omitted. It is therefore optional.

In one embodiment, this third step can employ the previous two phases simultaneously, that is to say to machine the blank simultaneously using on the one hand a laser with a centered axis and on the other hand an offset laser. These two machining steps can therefore be carried out in the same operation.

The third step has been described for partial machining of two adjacent teeth. It is naturally repeated for all the teeth of the blank. To this end the blank can be pivoted continuously or non-continuously during and/or after each machining step described above to present all the teeth to the offset laser. As previously mentioned, the offset laser is alternatively or additionally moved around the revolution axis of the blank.

Note that the respective chosen orientations of the laser and the blank enable not only simple formation of complex shapes but also an improved surface state to be obtained compared to traditional methods. At the end of the third step the timepiece component is finished or semi-finished. Nevertheless, the method of manufacture optionally further include a final finishing step to achieve a predetermined surface roughness.

For example such a final finishing step can be carried out using abrasive media, preferably on all of the surfaces of the timepiece component. In particular, this step can include mechanical treatment by impact using an abrasive mixture, preferably by vibratory, oscillatory or rotary movement, generally carried out in a tank. One or many timepiece components can be positioned in such a tank, in particular loose in bulk, to process them simultaneously.

Without this being limiting on the invention this final finishing step can be carried out by barrel polishing, tribofinishing, ultrafine sandblasting or wet spraying.

Furthermore this final finishing step is applied over all of the surface of a timepiece component, or alternatively over only a part of that surface, advantageously at least a visible surface of the timepiece component.

Alternatively this final finishing step can include polishing, which can be carried out directly by the laser machine used for the third step of the method. This polishing can be carried out continuously or non-continuously during or after the various laser ablation phases described above (third step).

In the embodiment described above the method of manufacture has been described for manufacturing an escapement pinion comprising teeth all having the same geometry. It can naturally be used to form any toothed timepiece component or any gear train. Furthermore, in all cases the teeth can all have the same profile or different profiles. The method is suitable for manufacturing a timepiece component comprising straight, helical, spiral or herringbone toothing and/or asymmetrical toothing and/or partial toothing and/or toothing evolving over the circumference, over the depth or over the length of the timepiece component. In all cases the invention is particularly advantageous in that it enables simple manufacture of any tooth and even more generally any shape comprising a transverse profile with at least one flared portion, whatever the shape of that flared portion, that is to say a portion having an orthoradial width that increases in the direction away from the revolution axis.

The method of the invention can be used to form numerous timepiece components. In particular it is useful for manufacturing a pinion or a toothed wheel as well as its shaft and/or a gear tooth. In fact one advantage is that the method enables simultaneous manufacture of a shaft and a toothed portion of the same timepiece component in a monobloc manner, i.e. in one piece, avoiding the disadvantages of posterior assembly of a separate shaft and a toothed portion.

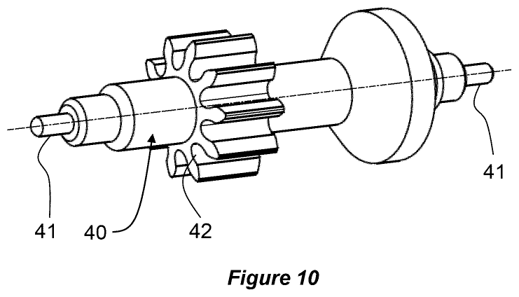

To this end FIG. 10 depicts a view of a monobloc timepiece component 40 according to the invention in one piece comprising a shaft with two pivots 41 at respective ends and a toothed pinion 42. FIG. 10 shows the transverse profile of each tooth 1 of the toothed pinion 42, which corresponds substantially to that in FIG. 1.

In this way this method of manufacture enables the manufacture of new shaft and/or teeth geometries optimizing meshing. For example it enables the configuration of shafts optimized for winding in one direction and unmeshing in the other direction.

The invention also relates to a timepiece component as such consisting in whole or in part of a material with a hardness greater than or equal to 800 HV or even greater than or equal to 1000 HV or even greater than or equal to 1200 HV, in particular a ceramic based on zirconia or alumina, and wherein it has a monobloc structure comprising a shaft and at least one tooth a section of which on a plane perpendicular to the shaft of the timepiece component has a shape including a flared portion.

The invention also relates to a machining device including at least one rotating spindle configured to hold a block to be machined and a laser that can be an offset laser configured to implement a method as described above for manufacturing a timepiece component.

Thanks to the invention a laser makes it possible to machine any material without requiring milling tools specific to one tooth shape. The use of milling tools is even more problematic in that they become degraded and must regularly be replaced. “Customized” designs of components and more specifically of flared teeth can therefore be produced.

1. A method of manufacturing a timepiece component, wherein the method includes:
procuring a block to be machined;
forming a timepiece component blank having a shape of revolution about an axis of revolution;
machining the blank using an off-center laser beam having a direction which is not parallel to the revolution axis, does not cross the revolution axis, and is not tangential to the blank to be machined.

2. The method as claimed in claim 1, wherein the machining of the blank forms at least one shape comprising a flared profile portion, a section of the blank normal to the revolution axis having a shape having an orthoradial dimension which increases in a direction radially away from the revolution axis.

3. The method as claimed in claim 1, wherein the machining of the employs a laser having a laser beam angle in a range of from 45 to 90 degrees relative to the revolution axis.

4. The method as claimed in claim 1, wherein the machining of the blank employs a laser producing an ultrashort pulse.

5. The method as claimed in claim 1, wherein the machining of the blank employs pivoting of the blank about the revolution axis and/or movement of the laser to access zones of the blank necessitating machining.

6. The method as claimed in claim 1, wherein the block to be machined is made entirely of ceramic or includes a ceramic coating.

7. The method as claimed in claim 6, wherein the ceramic is based on zirconia, or alumina, or a zirconia-alumina composite material, or silicon carbide, or silicon nitride.

8. The method as claimed in claim 1, wherein the block to be machined is made of a rigid and/or fragile and/or hard material having a hardness greater than or equal to 500 HV.

9. The method as claimed in claim 1, wherein the block is made of metal, or metal alloy, or an amorphous or partially amorphous metal alloy, or a titanium alloy, or tungsten, or a zirconium alloy, or a cermet, or a combination of some or all thereof.

10. The method as claimed in claim 1, wherein the method further comprises;
machining the blank using a centered laser generating a laser beam having a direction which crosses the revolution axis, the machining the blank using a centered laser being carried out before or at a same time as machining the blank using an off-center laser.

11. The method as claimed in claim 10, wherein the machining of the blank using the centered laser is carried out:
on the blank driven in continuous rotation and by a laser acting sequentially, and/or
on the blank driven in an oscillating manner.

12. The method as claimed in claim 1, wherein the forming of the timepiece component blank shaped with revolution symmetry includes:
extruding a mixture of powder and binder, or
performing (i) micro-injection and/or (ii) laser turning and machining, or
performing turning and machining by a cutting tool using a turning process.

13. The method as claimed in claim 1, wherein the method includes a final finishing step to achieve a predetermine surface roughness.

14. The method as claimed in claim 1, wherein the method manufactures all or part of a monobloc timepiece component including at least one shaft and at least one gear tooth over a depth or over a length of the timepiece component.

15. A machining device including at least one rotating spindle configured to hold a block to be machined and a laser that can be off-centered, the machine device being configured to employ a method of manufacturing a timepiece component, wherein the method includes;
procuring the block to be machined;
forming a timepiece component blank having a shape of revolution about an axis of revolution;
machining the blank using an off-center laser beam having a direction which is not parallel to the revolution axis, does not cross the revolution axis, and is not tangential to the blank to be machined.

16. A timepiece component,
wherein the timepiece component is made of a material having a hardness greater than or equal to 800 HV,
wherein the timepiece component has a monobloc structure comprising a shaft and at least one tooth having a section which on a plane perpendicular to the shaft has a shape including a flared profile portion, a section normal to the shaft having a shape in which an orthoradial dimension increases in a direction radially away from the rotation axis.

17. The method as claimed in claim 1, wherein the machining of the employs a laser having a laser beam angle in a range of from 70 to 90 degrees relative to the revolution axis.

18. The method as claimed in claim 4, wherein the machining of the blank employs a femtosecond pulse laser.

19. The method as claimed in claim 6, wherein the ceramic is a sintered and hardened technical ceramic.

20. The method as claimed in claim 6, wherein the ceramic is based on yttria-stabilized zirconia.
